(19) United States
(12) Patent Application Publication
(10) Pub. No.: US 2023/0185610 A1
(43) Pub. Date: Jun. 15, 2023

(54) ELECTRONIC COMMUNICATION AND TRANSACTION PROCESSING

(71) Applicant: BILLGO, INC., Fort Collins, CO (US)

(72) Inventors: Allison Rae Bast, Fort Collins, CO (US); Cindy L. Gamble-O'Neill, Fort Collins, CO (US); Frederick Charles Mahakian, Windsor, CO (US)

(73) Assignee: BILLGO, INC., Fort Collins, CO (US)

(21) Appl. No.: 17/546,733

(22) Filed: Dec. 9, 2021

(51) Int. Cl. G06F 9/50; G06F 9/46

(52) U.S. Cl. CPC G06F 9/5005; G06F 9/466

(57) ABSTRACT

Aspects of the present disclosure relate to electronic communication and transaction processing. In examples, for example where multiple senders each send an electronic communication indicating a resource for transfer to a recipient, a transaction platform may process such electronic communications to generate transaction information therefrom. Transaction entries associated with the recipient may be generated based on the transaction information, which may be presented to the recipient accordingly. In examples, the transaction platform may automatically process a transaction for one or more resources associated with a communication, such that the recipient need not manually review and manage the communications. In some instances, the transaction platform may combine multiple transaction entries, such that multiple such transactions can be presented and/or processed together, thereby further simplifying resource acquisition by the recipient.

### BACKGROUND

In examples, a sender may send or otherwise enable receipt of a resource by a recipient. For instance, an electronic communication may be received by the recipient, such that information therein may be used to process a transaction for the resource, such that the recipient obtains the resource from the sender accordingly. However, in instances where the recipient receives multiple electronic communications (e.g., from the same and/or different senders), processing transactions to obtain associated resources may be time consuming, prone to errors, and/or require additional resources, among other detriments.

It is with respect to these and other general considerations that embodiments have been described. Also, although relatively specific problems have been discussed, it should be understood that the embodiments should not be limited to solving the specific problems identified in the background.

### SUMMARY

Aspects of the present disclosure relate to electronic communication and transaction processing. In examples, for example where multiple senders each send an electronic communication indicating a resource for transfer to a recipient, a transaction platform may process such electronic communications to generate transaction information therefrom. Transaction entries associated with the recipient may be generated based on the transaction information, which may be presented to the recipient accordingly. In examples, the transaction platform may automatically process a transaction for one or more resources associated with a communication, such that the recipient need not manually review and manage the communications. In some instances, the transaction platform may combine multiple transaction entries, such that multiple such transactions can be presented and/or processed together, thereby further simplifying resource acquisition by the recipient.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 illustrates an overview of an example system for electronic communication and transaction processing.

FIG. 2 illustrates an overview of an example method for electronic communication and transaction processing.

FIG. 3 illustrates an overview of an example method for electronic communication processing to generate transaction information.

FIG. 4A illustrates an overview of an example method for providing a set of transaction entries for a recipient and processing a selected transaction entry.

FIG. 4B illustrates an overview of an example method for displaying a set of transaction entries and receiving a user selection of a transaction entry to be processed according to aspects described herein.

FIG. 5 illustrates an overview of an example user interface comprising a set of transaction entries.

FIG. 6 illustrates an overview of an example user interface comprising transaction information for a selected transaction entry.

FIG. 7 illustrates an example of a suitable operating environment in which one or more aspects of the present application may be implemented.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

In examples, a recipient may receive an electronic communication indicating a transaction of one or more resources from a sender to the recipient. Example resources include, but are not limited to, data, access to computing resources (e.g., processing time, memory, or storage), physical items or services, money, or currency. The electronic communication may comprise information that is usable by the recipient to obtain the resource from the sender. In some instances, the sender may use a computing device to transmit the electronic communication to a computing device associated with a recipient. As another example, the sender may provide an indication to a transaction agent, such that the transaction agent may generate an electronic communication to the recipient on behalf of the sender. Example electronic communications include, but are not limited to, emails, text messages, instant messages, webhooks, and application programming interface (API) calls.

Such an electronic communication (which is also referred to herein as a “resource transaction communication”) may comprise an alias associated with the sender, such that the recipient may use the sender alias to request receipt of or otherwise obtain the resource from the sender. In some instances, the sender alias may be a recipient-specific alias, such that the alias is unique at least from the perspective of the recipient. Put another way, the same or a similar alias may be used by a sender for another recipient in addition to the initial, but the initial recipient may not receive an electronic communication having that alias from a different sender. In other instances, the alias may be a one-time-use alias or may have a predetermined period of validity, after which a different alias will be used by the sender. Examples of a sender alias include, but are not limited to, a username, an email address, a phone number, or an account number. In some instances, a sender alias is provided by or otherwise associated with a resource manager, which may therefore enable the resource manager to identify a resource associated with the sender for receipt by the recipient.

In addition to or as an alternative to the sender information described above, it will be appreciated that a resource transaction communication may include a confirmation number, a sender and/or recipient address (e.g., an email address and/or a mailing address), a personal identification number (PIN) and/or other authorization information (e.g., a card verification value (CVV), an expiration date, and/or a cryptographic signature), and/or a resource indication of one or more resources associated therewith (e.g., as may be indicated by a globally unique identifier (GUID), a resource name, and/or a resource amount). In some instances, a resource transaction communication may include a link or other indication of a remote computing device, such that additional transaction information may be obtained from the remote computing device accordingly. For example, the link may be usable by a web browser of the recipient's computing device to access a website associated with a transaction agent of the sender, from which transaction information may be obtained.

However, in instances where a recipient receives multiple resource transaction communications (e.g., associated with the same sender and/or different senders), the recipient may need to manually handle each resource transaction communication to obtain one or more resources associated therewith. For example, the recipient may use a computing device to interact with a resource manager to obtain the sender's resources, for example based on a sender alias indicated by the resource transaction communication. As another example, the recipient may access a website of an associated transaction agent to complete a transaction or to obtain transaction information usable to complete the transaction. Performing this procedure may be tedious, have the potential for human error, and require additional resources on the part of the recipient if the recipient wishes to handle resource transaction communications in a timely manner, among other detriments. Additionally, these and other detriments may become more evident as the volume of resource transaction communications increases.

Accordingly, aspects of the present application relate to electronic communication and transaction processing. In examples, a transaction platform generates a recipient address to which resource transaction communications may be directed. The transaction platform may receive resource transaction communications on behalf of a recipient, which are processed according to aspects described herein. For example, a set of communication templates may be utilized by the transaction platform to process a resource transaction communication and generate transaction information associated with the resource transaction communication accordingly. The generated transaction information may include information extracted from the resource transaction communication and/or additional transaction information obtained from a transaction agent (e.g., based on a link of the resource transaction communication), among other examples.

The transaction platform may generate a transaction entry for each received resource transaction communication, which may be accessible by a recipient (e.g., via a website of the transaction platform or in an electronic communication in which resource transaction communications may be aggregated or summarized). In some instances, the transaction platform may aggregate transaction entries, as may be the case when multiple resource transaction communications having the same or a similar sender alias are received (e.g., as may be received from the same sender). In instances where the transaction platform manages or is otherwise associated with one or more sender aliases, the transaction platform may generate or update a consolidated alias, such that the consolidated alias is associated with resources of multiple resource transaction communications (e.g., each having an associated sender alias). Accordingly, the consolidated alias may be usable by the recipient to obtain resources associated therewith (e.g., rather than the sender aliases).

As another example, the transaction platform may automatically process transactions according to the generated transaction information, thereby facilitating automatic resource acquisition on behalf of the recipient. For example, the transaction platform may use a sender alias, transaction authorization information, a resource indication, and/or additional transaction information to communicate with a resource manager to retrieve, gain access to, or otherwise obtain one or more resources of a sender. In other examples, the transaction platform may itself process the transaction (e.g., absent involvement by a resource manager). The obtained resource(s) may be transferred to a resource manager of the recipient or stored by the transaction platform, among other examples.

Thus, as a result of processing resource transaction communications according to aspects described herein, the transaction platform may enable simplified resource acquisition by the recipient (e.g., via a consolidated alias and/or maintenance of transaction entries associated with the recipient) and may additionally or alternatively enable automatic resource acquisition as a result of automatic transaction processing. Such techniques may result in higher transaction processing throughput, reduced likelihood for errors and associated delays, and reduced resource consumption, among other technical benefits. Further, as a result of the added convenience provided by the instant aspects, senders and recipients may be more likely to transact according to the aspects described herein, which may further result in improved transaction reliability and security as compared to alternate resource transaction processing systems.

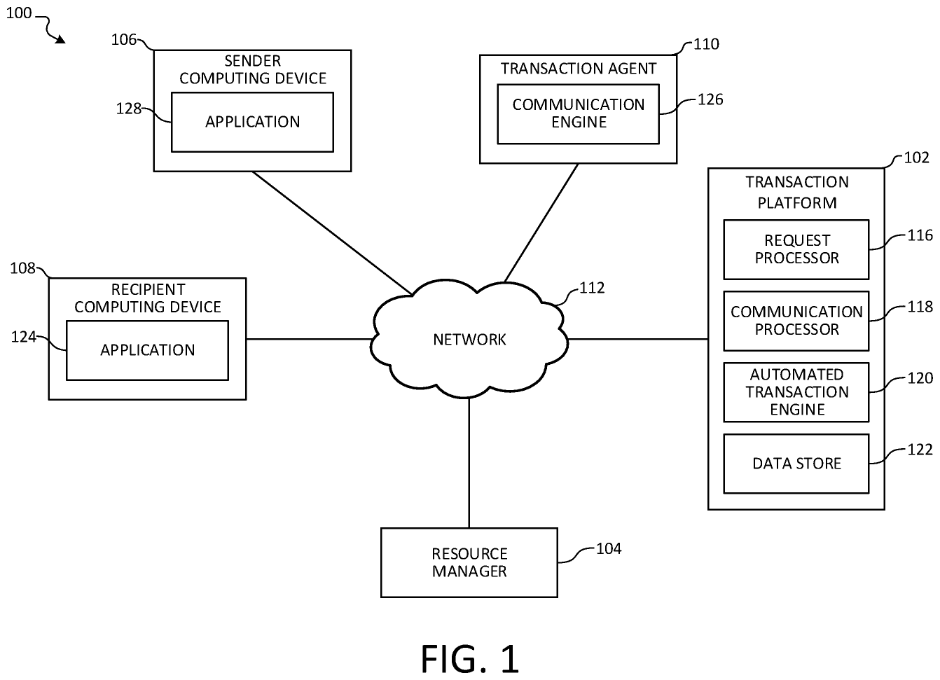

FIG. 1 illustrates an overview of an example system 100 for electronic communication and transaction processing. As illustrated, system 100 comprises transaction platform 102, resource manager 104, sender computing device 106, recipient computing device 108, transaction agent 110, and network 112. In examples, transaction platform 102, resource manager 104, sender computing device 106, recipient computing device 108, and transaction agent 110 communicate via network 112. For example, network 112 may comprise a local area network, a wireless network, or the Internet, or any combination thereof, among other examples.

Sender computing device 106 and recipient computing device 108 may each be any of a variety of computing devices, including, but not limited to, a desktop computing device, a laptop computing device, a tablet computing device, or a mobile computing device. As illustrated, sender computing device 106 and recipient computing device 108 are illustrated as comprising application 128 and application 124, respectively. Application 124 and 128 may each be any of a variety of applications, including, but not limited to, a native application, a web-based application, or any combination thereof.

In examples, application 128 of sender computing device 106 may be usable to cause a resource transaction communication to be sent to transaction platform 102 (e.g., as a result of the resource transaction communication being sent using a recipient address associated with transaction platform 102). For example, application 128 may be an email application or a web browser application. In examples, a sender uses application 128 to communicate with transaction agent 110, such that communication engine 126 of transaction agent 110 sends the resource transaction communication.

Application 124 may be any of a variety of applications, such as a web browser application or an application provided by transaction platform 102. In examples, application 124 enables a recipient to communicate with transaction platform 102. For example, application 124 may be used to access a website of transaction platform 102, as may be provided by request processor 116. Additional aspects of request processor 116 are discussed below.

System 100 is illustrated as further comprising resource manager 104. In some instances, one or more resources (e.g., of a sender or a recipient) may be managed by resource manager 104. For example, resource manager 104 may manage any of a variety of resources, including, but not limited to, data, items of monetary value, and/or currency. Thus, it will be appreciated that resource manager 104 may be associated with any of a variety of entities, including, but not limited to, a cloud services provider (e.g., which may manage data for a user) or a bank (e.g., which may manage assets of the user). In other examples, a resource need not be managed by resource manager 104.

As illustrated, transaction platform 102 comprises request processor 116, communication processor 118, automated transaction engine 120, and data store 122. In examples, communication processor 118 receives resource transaction communications (e.g., from sender computing device 106 or transaction agent 110) and processes the received resource transaction communications according to aspects described herein.

As noted above, a recipient (e.g., associated with recipient computing device 108) may have a recipient address associated with transaction platform 102, such that resource transaction communications directed to the recipient address are delivered to transaction platform 102 accordingly. As another example, a recipient may grant transaction platform 102 access to process resource transaction communications on behalf of the recipient, for example by permitting access to an email inbox or by setting up a forwarding rule to forward electronic communications to transaction platform 102 accordingly. Thus, it will be appreciated that resource transaction communications may be obtained by transaction platform 102 using any of a variety of techniques.

Communication processor 118 may process such received resource transaction communications. For example, communication processor 118 may identify a template from a set of communication templates (e.g., as may be stored by data store 122). In examples, a template may be identified based on a sender address, the type of communication (e.g., whether the communication is an email or an API call), and/or a sender alias, among other criteria. It will be appreciated that while template-based processing is used to process a resource transaction communication in the examples described herein, any of a variety of additional or alternative techniques may be used in other examples. For example, a machine learning model may be trained using reinforcement learning techniques and/or using annotated training data, such that transaction information may be extracted from a resource transaction communication using the machine learning model accordingly. As another example, transaction platform 102 may define or otherwise implement a resource transaction communication API, protocol, or format, such that conforming resource transaction communications may be parsed or otherwise processed by transaction platform 102 accordingly.

Thus, communication processor 118 generates transaction information for a resource transaction communication. In examples, communication processor 118 may fail to successfully extract transaction information from a resource transaction communication, such that a fallback extraction technique may be used or such that manual review of the resource transaction communication and correction of the extracted transaction information may be performed.

As discussed above, example transaction information includes, but is not limited to, a sender address, a sender alias, transaction authorization information, and/or a resource indication of one or more resources associated therewith. The transaction information may be extracted from the resource transaction communication and/or from additional transaction information (e.g., as may be obtained from transaction agent 110).

For example, communication processor 118 may identify a link within a resource transaction communication that is associated with transaction agent 110, such that communication processor 118 may communicate with transaction agent 110 accordingly. In examples, communication processor 118 may provide information extracted from the resource transaction communication or any of a variety of other information (e.g., authentication information provided by the recipient, as may be stored by data store 122) to obtain the additional transaction information accordingly. It will be appreciated that such additional transaction information may be obtained from any of a variety of alternative or additional data sources, including, but not limited to, resource manager 104.

Communication processor 118 may generate a transaction entry based on the generated transaction information, which may be stored in data store 122 in association with the recipient. In other examples, communication processor 118 may generate or update an aggregated transaction entry based on the generated transaction information, as may be the case when data store 122 already comprises a transaction entry having the same or a similar sender address or sender alias, among other examples. For example, the aggregated transaction entry may include a combined set of resources, where resources therein were associated with multiple received resource transaction communications.

Additionally or alternatively, communication processor 118 may generate or update a consolidated alias, as may be the case when transaction platform 102 manages or is otherwise associated with one or more sender aliases. Such a consolidated alias may be associated with resources of multiple resource transaction communications (e.g., each of which may be associated the same, similar, or different sender aliases). Accordingly, the consolidated alias may be usable (e.g., by the recipient and/or automated transaction engine 120) to obtain resources associated therewith. Such a consolidated alias may be stored in addition to or as an alternative to a sender alias in a transaction entry generated according to aspects described herein.

In some instances, communication processor 118 may provide an indication of a created or updated transaction entry, for example to recipient computing device 108. The indication may comprise a date at which the communication was received, a date at which the transaction would expire, and/or an indication of one or more resources associated with the communication, among other information. In examples, such an indication is provided for multiple transaction entries, as may be provided on a daily bases or after a predetermined number of resource transaction communications have been received, among other examples.

As noted above, application 124 of recipient computing device 108 may be used by a recipient to access transaction platform 102. For example, request processor 116 may receive a request for a set of transaction entries associated with a recipient. In examples, the request comprises an indication as to the recipient associated with the request, such that the set of entries may be determined from data store 122. Accordingly, at least a part of the determined set of transaction entries may be provided in response, such that application 124 presents them to the recipient. The recipient may select a transaction entry, such that request processor 116 may process a request for additional detail. As a result, at least a part of the transaction information of the transaction entry may be provided in response. In other examples, an indication may be received that the recipient has indicated that a transaction entry should be processed. Accordingly, automated transaction engine 120 may process the transaction entry accordingly, thereby obtaining one or more associated resources on behalf of the recipient. In other examples, the recipient may utilize transaction information presented by application 124 to manually obtain one or more resources associated therewith.

While examples herein are described in a context where transaction platform 102 permits a recipient to access associated transaction entries (e.g., using application 124), it will be appreciated that any of a variety of additional or alternative techniques may be used to present transaction entries to a recipient accordingly. For example, a summary or digest electronic communication may be generated and transmitted for presentation to a recipient in other examples.

Thus, automated transaction engine 120 may process a transaction entry in response to a recipient indication to do so and/or automatically. For instance, automated transaction engine 120 may receive an indication from request processor 116, as described above. In other examples, automated transaction engine 120 may automatically process a transaction entry as a result of an indication from communication processor 118 (e.g., as a result of communication processor 118 generating a transaction entry as described above). In examples, automated transaction engine 120 may communicate with resource manager 104 to obtain one or more sender resources on behalf of the recipient. In other examples, automated transaction engine 120 may process the transaction without resource manager 104, as may be the case when transaction platform 102 implements transaction processing capabilities.

Thus, automated transaction engine 120 may utilize transaction information of the transaction entry to process the transaction for the set of resources. Further, it will be appreciated that transactions may be processed individually or, in other examples, may be batched such that automated transaction engine 120 processes multiple transactions sequentially, substantially contemporaneously, or any combination thereof.

Automated transaction engine 120 may provide a status indication as a result of processing a transaction entry, for example an indication that the transfer was successful, an indication to provide manual input to complete the transaction, or an indication that the transfer failed. Such indications may further include additional information, such as information associated with transferred resources or a reason as to why a transfer failed. In other examples, automated transaction engine 120 may provide reconciliation data to another system (e.g., of the recipient), such that information associated with the transaction can be used to update other information maintained or used by the recipient.

While system 100 is illustrated as comprising two computing devices 106, a single transaction agent 110, a single resource manager 104, and a single transaction platform 102, it will be appreciated that, in other examples, any number of such elements may be used. Further, it will be appreciated that functionality described above with respect to specific elements of system 100 may be distributed according to any of a variety of other paradigms in other examples. For example, transaction platform 102 may further include aspects discussed above with respect to resource manager 104, such that it may act as a resource manager (e.g., for one or more recipients and/or senders).

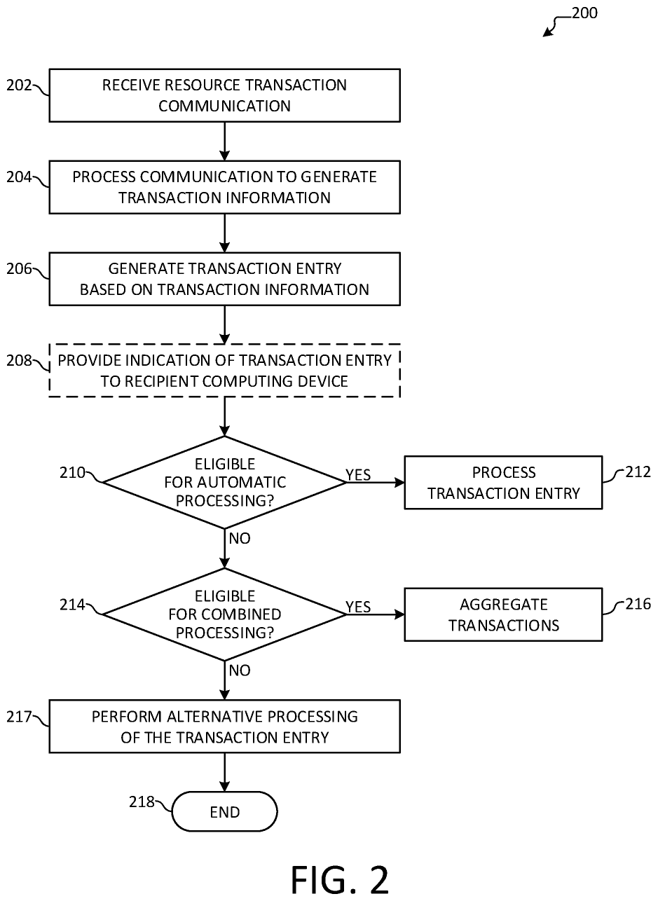

FIG. 2 illustrates an overview of an example method 200 for electronic communication and transaction processing. In examples, aspects of method 200 may be performed by a transaction platform, such as transaction platform 102 in FIG. 1.

Method 200 begins at operation 202, where a resource transaction communication is received. In examples, operation 202 comprises receiving the resource transaction communication from a sender computing device or a transaction agent, such as sender computing device 106 or transaction agent 110, respectively, in FIG. 1. In other examples, operation 202 may comprise accessing an inbox associated with a recipient and identifying a resource transaction communication that has not yet been processed. Thus, it will be appreciated that any a resource transaction communication may be obtained for processing by method 200 according to any of a variety of techniques.

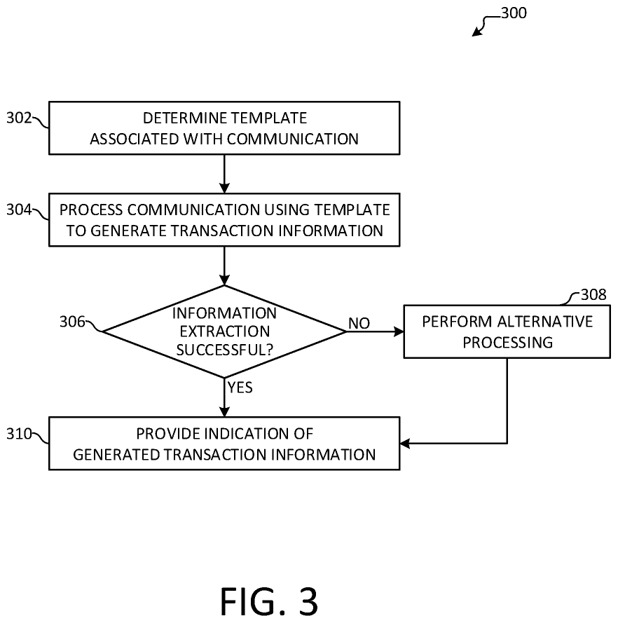

At operation 204, the resource transaction communication is processed to generate transaction information. As discussed above, transaction information can be generated from a resource transaction communication using any of a variety of techniques, including, but not limited to, identifying a communication template and processing the communication using the identified template, processing the communication using a machine learning model, or parsing the resource transaction communication based on its conformance to an API, protocol, or format, among other examples. Example operations that may be performed at operation 204 are discussed below with respect to FIG. 3. In some instances, operation 204 comprises communicating with a computing device to obtain additional transaction information, as may be the case when the resource transaction communication is determined to include a link (e.g., to a transaction agent or other computing device, such as transaction agent 110 in FIG. 1). Thus, example transaction information that may be generated at operation 204 includes, but is not limited to, a sender address, a sender alias, transaction authorization information, a resource indication, and/or additional transaction information.

Flow progresses to operation 206, where a transaction entry is generated based on the transaction information. For example, a transaction entry associated with a recipient may be generated in a data store, such as data store 122 in FIG. 1. The transaction entry includes the generated transaction information, for example as properties and values. In some examples, the transaction entry may include at least a part of the resource transaction communication. For instance, the resource transaction communication may be available for manual review in an instance where the generated transaction information is to be verified or is not correct. As another example, the resource transaction communication may be retained so as to provide an audit trail.

At operation 208, an indication of the transaction entry is provided to a recipient computing device. For example, the indication may alert the recipient that a resource transaction communication was received from a sender. The indication may include at least a part of the generated transaction information. Operation 208 is illustrated using a dashed box to indicate that, in other examples, operation 208 may be omitted. In other instances, rather than providing an indication every time a resource transaction communication is processed according to method 300, such indications may be batched into a single indication (e.g., on a daily basis or after a predetermined number of resource transaction communications have been received, among other examples).

At determination 210, it is determined whether the transaction entry is eligible for automatic processing. For example, a recipient may indicate that transactions associated with a predetermined set of senders should be automatically processed. In other examples, the recipient may indicate that transactions having certain resources should be automatically processed. In some instances, determination 210 may comprise determining whether a sender alias, resource manager, and/or transaction agent is associated with a transaction platform or otherwise configured to enable automatic transaction processing by the transaction platform. Thus, it will be appreciated that any of a variety of criteria may be evaluated at determination 210.

If it is determined at determination 210 that the transaction entry is eligible for automatic processing, flow branches “YES” to operation 212, where the transaction entry is processed. In examples, aspects of operation 212 may be performed by an automated transaction engine, such as automated transaction engine 120 discussed above with respect to FIG. 1. For example, operation 212 may comprise communicating with a resource manager associated with a resource of the resource transaction communication, thereby obtaining the resource on behalf of the recipient. Thus, transaction information of the transaction entry may be used to process the transaction accordingly. In some instances, operation 212 comprises providing a status indication as a result of processing a transaction entry (e.g., to a recipient computing device, such as recipient computing device 108 discussed above with respect to FIG. 1). Operation 212 may comprise updating the transaction entry to indicate the resulting status, such that it may be indicated that the transaction has been processed, that manual input is needed, or that the transaction has failed (e.g., permanently, temporarily, or may be retried). Method 200 terminates at operation 212.

Returning to determination 210, if it is instead determined that the transaction entry is not eligible for automatic processing, flow branches “NO” to determination 214, where it is determined whether the transaction entry is eligible for combined processing. In examples, determination 214 comprises determining whether a sender alias is the same as or similar to one or more other sender aliases of other transaction entries associated with the recipient. In other examples, determination 214 comprises determining whether a sender alias is associated with the transaction platform, such that a consolidated alias can be used. For instance, the consolidated alias may enable the transfer of resources associated with multiple resource transaction communications, even if the communications are from different senders and/or use different sender aliases. It will be appreciated that any of a variety of alternative or additional criteria may be used.

Accordingly, if it is determined that the transaction entry is eligible for combined processing, flow branches “YES” to operation 216, where such transactions are aggregated. For example, an aggregated transaction entry may be generated or updated, such that a single aggregated transaction entry is used in place of multiple transaction entries (e.g., one of which may have been generated at operation 206). As another example, an existing consolidated alias may be updated or a new consolidated alias maybe generated, such that the consolidated alias is associated with resources of multiple resource transaction communications. Accordingly, the consolidated alias may be usable by the recipient to obtain resources associated therewith. It will be appreciated that such aspects are provided as an example and, in other examples, any of a variety of other techniques may be used to provide the disclosed functionality. For example, determination 214 may be performed prior to operation 206, such that an aggregated transaction entry is generated in place of a single transaction entry associated with a resource transaction communication. Method 200 terminates at operation 216.

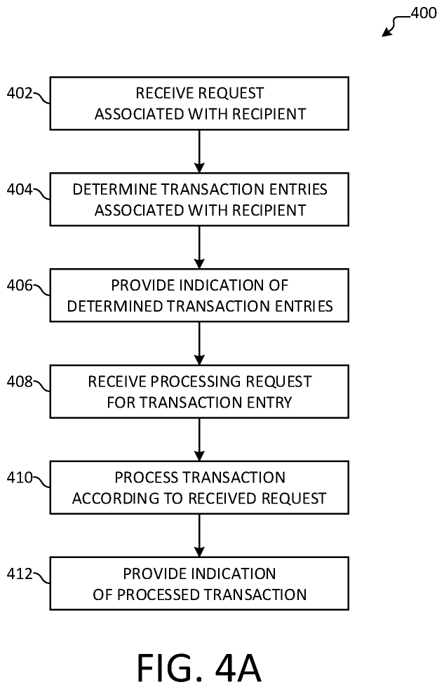

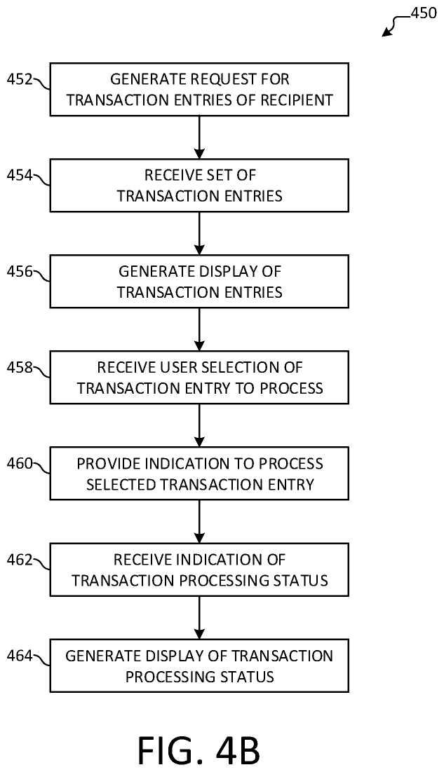

Returning to determination 214, if it is determined that the transaction entry is not eligible for combined processing, method 200 branches “NO” to operation 217, where alternative processing of the transaction entry may be performed. For example, operation 217 may include providing an indication of the transaction entry to a recipient computing device as a notification or as part of a website associated with a transaction platform (e.g., as may be performed by request processor 116 of transaction processor 102 discussed above with respect to FIG. 1), among other examples. In such examples, operation 217 may further comprise receiving an indication to process the transaction entry or, as another example, a user may use the transaction information provided as part of operation 217 to process the transaction manually (e.g., by providing the transaction information to another system). Additional aspects of such examples are discussed below with respect to FIGS. 4A and 4B. Method 200 terminates at operation 218.

FIG. 3 illustrates an overview of an example method 300 for electronic communication processing to generate transaction information. In examples, aspects of method 300 are performed by a transaction platform, such as transaction platform 102 discussed above with respect to FIG. 1. For example, communication processor 118 may perform the described aspects. In some instances, aspects of method 300 may be performed as part of operation 204 discussed above with respect to FIG. 2.

Method 300 begins at operation 302, where a template associated with a resource transaction communication is determined. In examples, a set of templates is stored in a data store, such as data store 122 discussed above with respect to FIG. 1. Each template may have an associated indication of a set of resource transaction communications for which it can be applied. For instance, a template may be associated with a transaction agent from which resource transaction communications may be received. As another example, a template may have an associated pattern for which it can be used (e.g., as may be applied to a sender address, sender alias, or more generally at least a part of the resource transaction communication). Thus, it will be appreciated that any of a variety of techniques may be used to determine a template with which to process a resource transaction communication.

Flow progresses to operation 304, where the resource transaction communication is processed using the determined template to generate transaction information. For example, the template may comprise a set of patterns usable to parse the resource transaction communication and extract transaction information accordingly. In some instances, the template may further comprise data validation logic, which may be processed at operation 304 to determine whether the generated transaction information is likely to be correct. As an example, the data validation logic may determine whether extracted transaction information is in an expected format (e.g., matching an expected format for a sender alias, a date, and/or a resource indication). In other instances, the template may comprise branching logic, as may be the case when a resource transaction communication may include different information depending on the scenario. For instance, if a sender alias matches a first predetermined format, a different pattern may be used to extract transaction authorization information as compared to instances when the sender alias matches a second predetermined format. It will be appreciated that such aspects are provided as examples and, in other examples, any of a variety of data extraction techniques may be used.

At determination 306, it is determined whether the transaction information extraction was successful. In examples, determination 306 comprises evaluating the result of the data validation logic discussed above. In other examples, determination 306 may comprise evaluating the generated transaction information as compared to one or more pre-existing transaction entries to determine whether the generated transaction information is consistent with previously received resource transaction communications. In some instances, a predetermined threshold may be used, such that a certainty below the predetermined threshold is determined to indicate that information extraction was not successful. Thus, it will be appreciated that any of a variety of techniques may be used to determine whether the transaction information was successfully extracted.

If, at determination 306, it is determined that information extraction was not successful, flow branches “NO” to operation 308, where alternative processing of the resource transaction communication is performed. For example, flow may branch “NO” when the format of a resource transaction communication has changed or a previously un-encountered resource transaction communication is received. In examples, a different set of templates may be applied at operation 308 similar to aspects discussed above with respect to operations 302 and 304. In another example, operation 308 may comprise providing an indication to a user to review the generated transaction information, such that the user may correct template information and/or the template that was applied at operation 304. It will be appreciated that any of a variety of alternative processing may be used at operation 308. Once the transaction information has been verified and/or corrected, flow progresses to operation 310, which is discussed below.

While method 300 is discussed in a context where templates are applied to process resource transaction communications, it will be appreciated that a process similar to operations 306, 308, and 310 may be applied to alternative communication processing techniques. For example, a confidence level generated by a machine learning model may be evaluated and used to determine whether an alternate machine learning model should be applied and/or whether the previously applied machine learning model should be retrained.

Returning to determination 306, if it is instead determined that the transaction information was successfully extracted, flow branches “YES” to operation 310, where an indication of the generated transaction information is provided. For example, the indication comprise the generated transaction information, thereby enabling subsequent processing of the transaction information (e.g., as described above with respect to method 200 in FIG. 2). Method 300 terminates at operation 310.

FIG. 4A illustrates an overview of an example method 400 for providing a set of transaction entries for a recipient and processing a selected transaction entry. In examples, aspects of method 400 are performed by a transaction platform, such as transaction platform 102 discussed above with respect to FIG. 1.

Method 400 begins at operation 402, where a request associated with a recipient is received. For example, the request may comprise an indication of the recipient, such as a recipient username, a recipient address, a session identifier, or any of a variety of other identifiers usable to determine the request is associated with the request. In examples, the request may be received from an application executing on a recipient computing device, such as application 124 of recipient computing 108 discussed above with respect to FIG. 1.

Flow progresses to operation 404, where transaction entries associated with the recipient are determined. In examples, the transaction entries are determined based on recency, such that a predetermined number of recent transactions may be determined. In other examples, the transaction entries may be determined according to a set of criteria (e.g., a sender, relating to an associated resource, or within a specified date range), as may have been received as part of the request that was received at operation 402. It will be appreciated that any of a variety of techniques and criteria may be used to determine transaction entries associated with the recipient. As another example, all associated transaction entries are determined.

Moving to operation 406, an indication of the determined transaction entries is provided in response to the request that was received at operation 402. For example, operation 406 may comprise providing at least a part of the transaction information of each determined transaction entry. In other examples, at least a part of a resource transaction correspondence may be provided.

At operation 408, a processing request is received for a transaction entry. For example, the processing request may be received as a result of a recipient specifying that the transaction should be processed. In examples, the request comprises an indication of the transaction entry to process, such as an identifier associated with the transaction entry. As another example, the request may comprise at least a part of the transaction information itself, such as a resource indication and a sender alias, among other information.

Flow progresses to operation 410, where the transaction is processed according to the received request. For example, aspects of operation 410 may be performed by an automated transaction engine, such as automated transaction engine 120 discussed above with respect to FIG. 1. For example, operation 410 may comprise communicating with an associated resource manager associated, thereby obtaining the resource on behalf of the recipient. Thus, similar to operation 212 of method 200 discussed above with respect to FIG. 2, operation 410 comprises utilizing transaction information of the transaction entry to process the transaction accordingly.

At operation 412, a status indication is provided in response to the request that was received at operation 408. In some instances, operation 412 further comprises updating the transaction entry to indicate the resulting status of operation 410, such that it indicates to the recipient that the transaction has been processed, that manual input is needed, or that the transaction has failed (e.g., permanently, temporarily, or may be retried). Method 400 terminates at operation 412.

It will be appreciated that method 400 is provided as an example exchange between a transaction platform and a recipient computing device and that, in other examples, any of a variety of additional or alternative exchanges may occur. For example, operations 402-406 and 408-412 need not occur sequentially. Rather, operations 402-406 may be performed multiple times, while operations 408-412 may occur less frequently. For example, operations 402-406 may be performed to provide determined transaction entries to a recipient computing device as a recipient browses through pages of transaction entries, while operations 408-412 may be performed once the recipient has identified a transaction entry to process. As another example, operations 408-412 may be performed multiple times after operations 402-406 are performed, for instance as the recipient indicates multiple transaction entries that are presented to the recipient should be processed. As a further example, operation 408 may comprise receiving an indication to process multiple transaction entries, such that operations 410 and 412 process a plurality of transaction entries accordingly. Another example exchange includes, but are not limited to, receiving request for and subsequent providing transaction detail.

FIG. 4B illustrates an overview of an example method 450 for displaying a set of transaction entries and receiving a user selection of a transaction entry to be processed according to aspects described herein. In examples, aspects of method 450 may be performed by an application of a recipient computing device, such as application 124 of recipient computing device 108 discussed above with respect to FIG. 1.

Method 450 begins at operation 450, where a request for transaction entries of a recipient is generated. In examples, the request comprises an indication as to the recipient and/or a set of criteria for which matching transaction entries should be identified. The request may be generated as a result of user input received at an application of a recipient computing device, such as a web browser or an application associated with a transaction platform (e.g., transaction platform 102 discussed above with respect to FIG. 1). The request may be provided to the transaction platform. It will be appreciated that additional or alternative information may be included in the request in other examples.

At operation 454, a set of transaction entries are received in response. For example, the set of transaction entries may be received as a result of the transaction platform performing aspects of operations 404 and 406 discussed above with respect to method 400 in FIG. 4A.

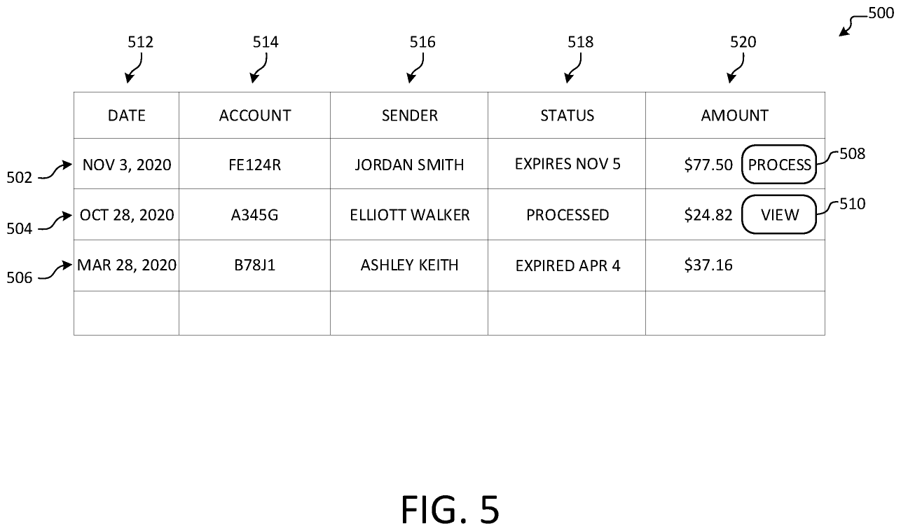

At operation 456, a display of transaction entries is generated. For example, a row may be displayed for each transaction entry, where each row includes an indication of an associated sender, resource, and/or date, among other examples. Examples of such aspects are illustrated in FIG. 5, which is discussed below.

Flow progresses to operation 458, where a user selection is received of an entry to process. For example, the display generated at operation 456 may include a user interface element that may be actuated by the recipient to indicate that the transaction entry should be processed. As another example, similar aspects may be performed in response to a user interaction with an email, a text message, or a mobile notification, among other examples. In other instances, each transaction entry may be displayed in association with a checkbox or other selection element that may be actuated by a user, thereby enabling selection of multiple transaction entries.

At operation 460, an indication to process the selected transaction entry (or entries, in other examples) is provided to the transaction platform. In some instances, the indication may comprise an identifier associated with the transaction entry or may include at least a part of the transaction information, among other examples.

Moving to operation 462, an indication of the transaction processing status is received. For example, the indication may be received as a result of the transaction platform performing aspects of operations 410 and 412 discussed above with respect to method 400 of FIG. 4A. The status may indicate that processing was successful, that the transaction platform is awaiting manual input by the recipient, or that the transaction failed (and, in some examples, will be retried). Thus, it will be appreciated that any of a variety of indications may be received.

Flow progresses to operation 464, where a display of the received transaction processing status is generated. For example, the status may be presented as a pop-up or alert. As another example, a row associated with the transaction entry may be updated accordingly. Any of a variety of additional or alternative techniques may be used to provide an indication of transaction status without departing from the instant disclosure. Method 450 terminates at operation 460.

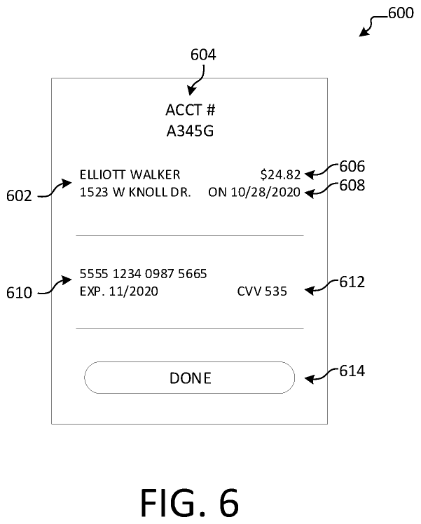

Similar to method 400 of FIG. 4A, method 450 is provided as an example exchange between a transaction platform and a recipient computing device. Accordingly, it will be appreciated that, in other examples, any of a variety of additional or alternative exchanges may occur. For example, operations 452-456 and 458-464 need not occur sequentially. Rather, operations 452-456 may be performed multiple times (e.g., as a recipient browses multiple pages of transaction entries), while operations 458-464 may occur less frequently. Similarly, operations 458-464 may be performed multiple times, for instance as a recipient indicates multiple presented transaction entries should be processed. In examples, operations 452-456 are performed in conjunction with operations 402-406 discussed above, for example such that a recipient computing device performs operations 452-456 and a transaction platform performs operations 402-406. Similarly, operations 458-464 may be performed (e.g., by the recipient computing device) in conjunction with operations 408-412 (e.g., as may be performed by the transaction platform. Another example exchange includes requesting and subsequently receiving details associated with a transaction entry. An example of such aspects is discussed below with respect to FIG. 6.

FIG. 5 illustrates an overview of an example user interface 500 comprising a set of transaction entries. In examples, user interface 500 may be displayed at a recipient computing device (e.g., by application 124 of recipient computing device 108 discussed above with respect to FIG. 1). For example, user interface 500 may be displayed as a result of operations 452-456 discussed above with respect to method 450 of FIG. 4B.

As illustrated, user interface 550 comprises transaction entries 502, 504, and 506, each of which have information for date column 512, account column 514, customer column 516, status column 518, and sender column 520. It will be appreciated that columns 512-520 are provided as examples and, in other examples, additional, alternative, or fewer columns may be used to present transaction information associated with transaction entries 502, 504, and 506.

With reference to transaction entry 502, the resource transaction has not yet been processed nor expired (as evidenced by the expiration date in the future in status column 518). Accordingly, process user interface element 508 is presented, which may be actuated by a recipient to cause the transaction for the resource to be processed accordingly. Such aspects may be similar to those discussed above with respect to operations 458-464 of method 450 in FIG. 4B.

Transaction entry 504 is provided to illustrate another example interaction between a recipient and a transaction platform. For example, transaction entry 504 was previously processed (as indicated in status column 518), as may have occurred as a result of a manual indication or automatically according to aspects described herein. Accordingly, view user interface element 510 is presented, which may be actuated by the recipient to view additional detail associated with the transaction. An example user interface associated with presenting additional detail to the recipient is discussed with respect to FIG. 6, which illustrates an overview of an example user interface 600 comprising transaction information for a selected transaction entry.

As illustrated, user interface 600 includes sender information 602, account 604, resource indication 606, send date 608, sender alias 610, transaction authorization information 612, and done user interface element 614. Thus, detail presented associated with a transaction entry may enable a recipient to manually handle a transaction (e.g., using sender alias 610, resource indication 606, and transaction authorization information 612). Account 604 may be an identifier managed or otherwise associated with the recipient, such that a ledger of the recipient is manually or automatically updated (e.g., as may be performed by an automated transaction engine, such as automated transaction engine 120 in FIG. 1) as a result of the transaction accordingly.

In the illustrated example, done user interface element 614 is presented, as the transaction has already been processed (as discussed above with respect to transaction entry 504 in FIG. 5). In instances where the transaction has not yet been processed, a user interface element may be presented that, when actuated, provides an indication to process the transaction. Similar aspects were discussed above with respect to operations 408-412 and operations 458-464 of FIGS. 4A and 4B, respectively.

While example transaction information is shown in user interface 600, it will be appreciated that alternative, additional, or less information may be presented in other examples. For example, the information presented may vary depending on the type of resource indicated by resource indication 606), sender alias 610, and/or transaction authorization information 612.

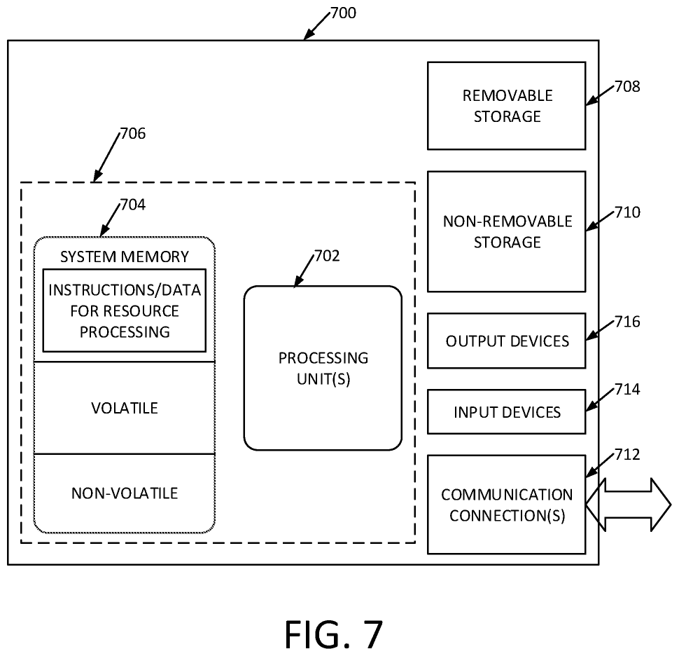

FIG. 7 illustrates an example of a suitable operating environment 700 in which one or more of the present embodiments may be implemented. This is only one example of a suitable operating environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smart phones, network PCs, minicomputers, mainframe computers, distributed computing environments that include any of the above systems or devices, and the like.

In its most basic configuration, operating environment 700 typically may include at least one processing unit 702 and memory 704. Depending on the exact configuration and type of computing device, memory 704 (storing, among other things, APIs, programs, etc. and/or other components or instructions to implement or perform the system and methods disclosed herein, etc.) may be volatile (such as RAM), non-volatile (such as ROM, flash memory, etc.), or some combination of the two. This most basic configuration is illustrated in FIG. 7 by dashed line 706. Further, environment 700 may also include storage devices (removable, 708, and/or non-removable, 710) including, but not limited to, magnetic or optical disks or tape. Similarly, environment 700 may also have input device(s) 714 such as a keyboard, mouse, pen, voice input, etc. and/or output device(s) 716 such as a display, speakers, printer, etc. Also included in the environment may be one or more communication connections, 712, such as LAN, WAN, point to point, etc.

Operating environment 700 may include at least some form of computer readable media. The computer readable media may be any available media that can be accessed by processing unit 702 or other devices comprising the operating environment. For example, the computer readable media may include computer storage media and communication media. The computer storage media may include volatile and nonvolatile, removable and non-removable media implemented in any method or technology for storage of information such as computer readable instructions, data structures, program modules or other data. The computer storage media may include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium, which can be used to store the desired information. The computer storage media may not include communication media.

The communication media may embody computer readable instructions, data structures, program modules, or other data in a modulated data signal such as a carrier wave or other transport mechanism and includes any information delivery media. The term “modulated data signal” may mean a signal that has one or more of its characteristics set or changed in such a manner as to encode information in the signal. For example, the communication media may include a wired media such as a wired network or direct-wired connection, and wireless media such as acoustic, RF, infrared and other wireless media. Combinations of the any of the above should also be included within the scope of computer readable media.

The operating environment 700 may be a single computer operating in a networked environment using logical connections to one or more remote computers. The remote computer may be a personal computer, a server, a router, a network PC, a peer device or other common network node, and typically includes many or all of the elements described above as well as others not so mentioned. The logical connections may include any method supported by available communications media. Such networking environments are commonplace in offices, enterprise-wide computer networks, intranets and the Internet.

The different aspects described herein may be employed using software, hardware, or a combination of software and hardware to implement and perform the systems and methods disclosed herein. Although specific devices have been recited throughout the disclosure as performing specific functions, one skilled in the art will appreciate that these devices are provided for illustrative purposes, and other devices may be employed to perform the functionality disclosed herein without departing from the scope of the disclosure.

As stated above, a number of program modules and data files may be stored in the system memory 704. While executing on the processing unit 702, program modules (e.g., applications, Input/Output (I/O) management, and other utilities) may perform processes including, but not limited to, one or more of the stages of the operational methods described herein such as the methods illustrated in FIG. 1, 2, 3, 4A, or 4B, for example.

Furthermore, examples of the invention may be practiced in an electrical circuit comprising discrete electronic elements, packaged or integrated electronic chips containing logic gates, a circuit utilizing a microprocessor, or on a single chip containing electronic elements or microprocessors. For example, examples of the invention may be practiced via a system-on-a-chip (SOC) where each or many of the components illustrated in FIG. 7 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality described herein may be operated via application-specific logic integrated with other components of the operating environment 700 on the single integrated circuit (chip). Examples of the present disclosure may also be practiced using other technologies capable of performing logical operations such as, for example, AND, OR, and NOT, including but not limited to mechanical, optical, fluidic, and quantum technologies. In addition, examples of the invention may be practiced within a general purpose computer or in any other circuits or systems.

As will be understood from the foregoing disclosure, one aspect of the technology relates to a system comprising: at least one processor; and memory storing instructions that, when executed by the at least one processor, causes the system to perform a set of operations. The set of operations comprises: receiving a resource transaction communication associated with a sender and a recipient; processing the resource transaction communication to generate transaction information comprising a sender alias and a resource indication; generating a transaction entry associated with the recipient, wherein the transaction entry comprises the sender alias and the resource indication; and processing a transaction for a resource indicated by the resource indication, thereby transferring the resource from the sender to the recipient. In an example, the resource transaction communication is a first resource transaction communication; the sender is a first sender; the sender alias is a first sender alias; the resource indication is a first resource indication; the transaction entry is a first transaction entry; and the set of operations further comprises: receiving a second resource transaction communication associated with a second sender and the recipient, wherein the second sender is different from the first sender; and generating, based on the second resource transaction communication, a second transaction entry associated with the recipient. In another example, the second transaction entry is an aggregated transaction entry for the first resource transaction communication and the second resource transaction communication. In a further example, the aggregated transaction entry comprises a consolidated alias associated with: a first set of resources of the first sender alias; and a second set of resources of a second sender alias of the second resource transaction communication. In yet another example, the transaction is processed automatically as a result of a determination that the generated transaction entry is eligible for automatic processing. In a further still example, the transaction is processed in response to receiving, from a computing device associated with the recipient, an indication to process the transaction entry. In another example, processing the resource transaction communication comprises: determining, for the resource transaction communication, a communication template from a set of communication templates; extracting the transaction information using the determined communication template; and validating the extracted transaction information according to a set of data validation rules of the communication template. In a further example, processing the resource transaction communication further comprises: based on determining that the transaction information was not successfully extracted, performing alternative processing of the resource transaction communication to generate the transaction information.

In another aspect, the technology relates to a method for processing a resource transaction communication. The method comprises: receiving a resource transaction communication associated with a sender and a recipient; determining, for the resource transaction communication, a communication template from a set of communication templates; extracting, using the determined communication template, transaction information comprising a sender alias and a resource indication; generating a transaction entry associated with the recipient, wherein the transaction entry comprises the sender alias and the resource indication; and storing, in a data store, the transaction entry in association with the recipient. In an example, the method further comprises: determining that the transaction information was not successfully extracted; and performing alternative processing of the resource transaction communication to generate the transaction information. In another example, alternative processing comprises at least one of: determining a fallback communication template from a fallback set of communication templates; or receiving user input to at least one of: update the determined template; or modify the extracted transaction information. In a further example, the transaction information further comprises authorization information and a link; the method further comprises obtaining, based on the link, additional transaction information from a computing device associated with the link; and the transaction entry further comprises the authorization information and the obtained additional transaction information.

In a further aspect, the technology relates to a method for processing a resource transaction communication. The method comprises: receiving a resource transaction communication associated with a sender and a recipient; processing the resource transaction communication to generate transaction information comprising a sender alias and a resource indication; generating a transaction entry associated with the recipient, wherein the transaction entry comprises the sender alias and the resource indication; and processing a transaction for a resource indicated by the resource indication, thereby transferring the resource from the sender to the recipient. In an example, the resource transaction communication is a first resource transaction communication; the sender is a first sender; the sender alias is a first sender alias; the resource indication is a first resource indication; the transaction entry is a first transaction entry; and the method further comprises: receiving a second resource transaction communication associated with a second sender and the recipient, wherein the second sender is different from the first sender; and generating, based on the second resource transaction communication, a second transaction entry associated with the recipient. In another example, the second transaction entry is an aggregated transaction entry for the first resource transaction communication and the second resource transaction communication. In a further example, the aggregated transaction entry comprises a consolidated alias associated with: a first set of resources of the first sender alias; and a second set of resources of a second sender alias of the second resource transaction communication. In yet another example, the transaction is processed automatically as a result of a determination that the generated transaction entry is eligible for automatic processing. In a further still example, the transaction is processed in response to receiving, from a computing device associated with the recipient, an indication to process the transaction entry. In another example, processing the resource transaction communication comprises: determining, for the resource transaction communication, a communication template from a set of communication templates; extracting the transaction information using the determined communication template; and validating the extracted transaction information according to a set of data validation rules of the communication template. In a further example, processing the resource transaction communication further comprises: based on determining that the transaction information was not successfully extracted, performing alternative processing of the resource transaction communication to generate the transaction information.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system comprising:
at least one processor; and
memory storing instructions that, when executed by the at least one processor, causes the system to perform a set of operations, the set of operations comprising:
receiving a resource transaction communication associated with a sender and a recipient;
processing the resource transaction communication to generate transaction information comprising a sender alias and a resource indication;
generating a transaction entry associated with the recipient, wherein the transaction entry comprises the sender alias and the resource indication; and
processing a transaction for a resource indicated by the resource indication, thereby transferring the resource from the sender to the recipient.

2. The system of claim 1, wherein:
the resource transaction communication is a first resource transaction communication;
the sender is a first sender;
the sender alias is a first sender alias;
the resource indication is a first resource indication;
the transaction entry is a first transaction entry; and
the set of operations further comprises:
receiving a second resource transaction communication associated with a second sender and the recipient, wherein the second sender is different from the first sender; and
generating, based on the second resource transaction communication, a second transaction entry associated with the recipient.

3. The system of claim 2, wherein the second transaction entry is an aggregated transaction entry for the first resource transaction communication and the second resource transaction communication.

4. The system of claim 3, wherein the aggregated transaction entry comprises a consolidated alias associated with:
a first set of resources of the first sender alias; and
a second set of resources of a second sender alias of the second resource transaction communication.

5. The system of claim 1, wherein the transaction is processed automatically as a result of a determination that the generated transaction entry is eligible for automatic processing.

6. The system of claim 1, wherein the transaction is processed in response to receiving, from a computing device associated with the recipient, an indication to process the transaction entry.

7. The system of claim 1, wherein processing the resource transaction communication comprises:
determining, for the resource transaction communication, a communication template from a set of communication templates;
extracting the transaction information using the determined communication template; and
validating the extracted transaction information according to a set of data validation rules of the communication template.

8. The system of claim 7, wherein processing the resource transaction communication further comprises:
based on determining that the transaction information was not successfully extracted, performing alternative processing of the resource transaction communication to generate the transaction information.

9. A method for processing a resource transaction communication, comprising:
receiving a resource transaction communication associated with a sender and a recipient;
determining, for the resource transaction communication, a communication template from a set of communication templates;
extracting, using the determined communication template, transaction information comprising a sender alias and a resource indication;
generating a transaction entry associated with the recipient, wherein the transaction entry comprises the sender alias and the resource indication; and
storing, in a data store, the transaction entry in association with the recipient.

10. The method of claim 9, further comprising:
determining that the transaction information was not successfully extracted; and
performing alternative processing of the resource transaction communication to generate the transaction information.

11. The method of claim 10, wherein alternative processing comprises at least one of:
determining a fallback communication template from a fallback set of communication templates; or
receiving user input to at least one of:
update the determined template; or
modify the extracted transaction information.

12. The method of claim 11, wherein:
the transaction information further comprises authorization information and a link;
the method further comprises obtaining, based on the link, additional transaction information from a computing device associated with the link; and
the transaction entry further comprises the authorization information and the obtained additional transaction information.

13. A method for processing a resource transaction communication, comprising:
receiving a resource transaction communication associated with a sender and a recipient;
processing the resource transaction communication to generate transaction information comprising a sender alias and a resource indication;
generating a transaction entry associated with the recipient, wherein the transaction entry comprises the sender alias and the resource indication; and
processing a transaction for a resource indicated by the resource indication, thereby transferring the resource from the sender to the recipient.

14. The method of claim 13, wherein:
the resource transaction communication is a first resource transaction communication;
the sender is a first sender;
the sender alias is a first sender alias;
the resource indication is a first resource indication;
the transaction entry is a first transaction entry; and
the method further comprises:
receiving a second resource transaction communication associated with a second sender and the recipient, wherein the second sender is different from the first sender; and
generating, based on the second resource transaction communication, a second transaction entry associated with the recipient.

15. The method of claim 14, wherein the second transaction entry is an aggregated transaction entry for the first resource transaction communication and the second resource transaction communication.

16. The method of claim 15, wherein the aggregated transaction entry comprises a consolidated alias associated with:
a first set of resources of the first sender alias; and
a second set of resources of a second sender alias of the second resource transaction communication.

17. The method of claim 13, wherein the transaction is processed automatically as a result of a determination that the generated transaction entry is eligible for automatic processing.

18. The method of claim 13, wherein the transaction is processed in response to receiving, from a computing device associated with the recipient, an indication to process the transaction entry.

19. The method of claim 13, wherein processing the resource transaction communication comprises:
determining, for the resource transaction communication, a communication template from a set of communication templates;
extracting the transaction information using the determined communication template; and validating the extracted transaction information according to a set of data validation rules of the communication template.

20. The method of claim 19, wherein processing the resource transaction communication further comprises:
based on determining that the transaction information was not successfully extracted, performing alternative processing of the resource transaction communication to generate the transaction information.
